(19) United States
(12) Patent Application Publication
(10) Pub. No.: US 2026/0063191 A1
(43) Pub. Date: Mar. 5, 2026

(54) ELECTRIC DRIVE SYSTEM FOR A MOTOR VEHICLE, AND MOTOR VEHICLE

(71) Applicant: MERCEDES-BENZ GROUP AG, Stuttgart (DE)

(72) Inventors: Tobias SCHILDER, Ludwigsburg (DE); Tobias HAERTER, Stuttgart (DE)

(21) Appl. No.: 19/107,202

(22) PCT Filed: Aug. 14, 2023
(86) PCT No.: PCT/EP2023/072397

§ 371 Date: Feb. 27, 2025

(30) Foreign Application Priority Data
Sep. 1, 2022 (DE) 10 2022 003 206.6

(51) Int. Cl. F16H 37/08; B60K 1/00; B60K 17/08; B60K 17/16; F16H 57/02; F16H 57/037; F16H 57/08; H02K 7/116; H02K 21/24

(52) U.S. Cl. CPC F16H 37/082; B60K 1/00; B60K 17/08; B60K 17/165; F16H 57/037; F16H 57/082; H02K 7/116; H02K 21/24; B60K 2001/001; F16H 2057/02034; F16H 2057/02052; F16H 2057/085

(57) ABSTRACT

An electric drive system for a motor vehicle includes an electric engine having a stator and a rotor, and a planetary gearbox having a first planetary gear set, which has a first sun gear, a first planetary carrier, and a first ring gear. A second planetary gear set, which has a second sun gear, a second planetary carrier, and a second ring gear, is arranged radially outside and axially overlapping the first planetary gear set with regard to a rotational axis of the planetary gearbox. A differential gear includes a first crown wheel, a second crown wheel, and pinion gears arranged axially between the crown wheels and meshing with these.

### BACKGROUND AND SUMMARY OF THE INVENTION

Exemplary embodiments of the invention relate to an electric drive system for a motor vehicle, as well as to a motor vehicle having at least one such electric drive system.

An electric drive device for a motor vehicle is taken as known from DE 10 2018 008 939 B3. Furthermore, DE 10 2014 000 499 A1 discloses a differential gear for a motor vehicle, wherein an output gear wheel can be designed as a crown wheel DE 11 2004 002 526 B4 similarly refers to a crown wheel differential. An electric drive device having two planetary gear sets which are nested radially inside each other is known from the generic DE 10 2017 006 266 A1. An electric drive device having an electric engine designed as an axial flow machine is known from DE 10 2021 103 176 A1.

Exemplary embodiments of the present invention are directed to an electric drive system for a motor vehicle and a motor vehicle having such an electric drive system, so that a particularly compact construction can be implemented.

A first aspect of the invention relates to an electric drive system, also referred to as an electric drive device or formed as an electric drive device, for a motor vehicle. This means that the motor vehicle, also referred to simply as a vehicle, has the electric drive system in its completely produced state and can be driven electrically by means of the electric drive system, in particular purely electrically. For example, the motor vehicle, in its completely produced state, has at least or exactly two vehicle axles, also referred to simply as axles, arranged successively and thus one behind the other in the vehicle longitudinal direction of the motor vehicle. The respective vehicle axle has at least or exactly two vehicle wheels, also referred to simply as wheels, for example. The respective vehicle wheels of the respective vehicle axle are arranged on opposite sides to one another in the vehicle transverse direction of the motor vehicle, for example. The vehicle wheels are ground contact elements, by means of which the motor vehicle is or can be supported downwards on the ground in the vehicle vertical direction of the motor vehicle. For example, the motor vehicle is designed as an automobile, in particular a passenger car. If the motor vehicle drives along the ground while the motor vehicle is supported downwards on the ground by the ground contact elements in the vehicle vertical direction, the ground contact elements (vehicle wheels) roll, in particular directly, on the ground. For example, the vehicle wheels of at least or exactly one of the vehicle axles or both vehicle axles can be driven, in particular purely, electrically, by means of the electric drive system. The vehicle wheels driven by means of the electric drive system are also referred to as drive wheels. When the vehicle wheels are referred to in the following, unless otherwise stated, this means the drive wheels.

The electric drive system has an electric engine having a stator and a rotor. For example, the stator can be driven by means of the rotor and thus can be rotated around an engine rotational axis relative to the rotor. In particular, the electric engine can provide drive torques via its rotor, by means of which the motor vehicle, in particular the vehicle wheels, can be electrically driven.

The electric drive system also has a planetary gearbox. For example, the electric drive system comprises a housing, wherein for example the planetary gearbox can be arranged at least partially in the housing. The planetary gearbox has a first planetary gear set, which is also referred to as a first planetary set. The first planetary gear set has a first sun gear, a first planetary carrier, and a first ring gear. The first sun gear, the first planetary carrier, and the first ring gear are first gear elements of the planetary gear set. Particularly if the respective first gear element is not connected to the housing for conjoint rotation, for example the respective first gear element can be rotated around a first planetary gear set rotational axis, relative to the housing.

The planetary gearbox also has a second planetary gear set, which is also referred to as a second planetary set. The second planetary gear set has a second sun gear, a second planetary carrier, and a second ring gear. The second sun gear, the second planetary carrier, and the second ring gear are the second gear elements of the second planetary gear set. Particularly if the respective second gear element is not connected to the housing for conjoint rotation, the respective second gear element can be rotated around a second planetary gear set rotational axis, relative to the housing. In particular, the planetary gear sets are arranged coaxially to each other, in particular with regard to the planetary gear set rotational axes, so that the planetary gear set rotational axes coincide. The planetary gear set rotational axes extend along or form a common rotational axis. In other words, the respective planetary gear set rotational axis is also referred to as a rotational axis.

The second planetary gear set is arranged radially outside and axially overlapping the first planetary gear set, with regard to the rotational axis of the planetary gearbox.

Unless otherwise specified, in the present disclosure, the terms “axial” and “radial” refer to the rotational axis of the planetary gearbox, with respect to which the first gear elements and for example also the second gear elements are coaxially arranged. “Radially inside” is understood in particular to mean the following: An, in particular rotatably mounted, element, such as the first planetary gear set, is arranged radially inside another, in particular rotatably mounted, element, such as the first planetary gear set, if it is arranged in a region with smaller radii, in particular viewed in the radial direction of the planetary gearbox and thus of the electric drive system, the radial direction of which extends perpendicular to the axial direction of the planetary gearbox and thus the electric drive system. The axial direction coincides with the rotational axis. “Radially outside” is accordingly to be understood to mean that an, in particular rotatably mounted, element is arranged radially outside another, in particular rotatably mounted, element if it is arranged in a region with larger radii.

In particular, “axially overlapping” is to be understood to mean the following: Two elements, such as the planetary gear sets, are arranged axially overlapping, in particular with respect to each other, as viewed in particular along the rotational axis and thus in the axial direction of the planetary gearbox and of the drive system, when they are at least partially arranged in an identical axial region. Expressed in other words, two elements are arranged axially overlapping, in particular with respect to each other, when these two elements have at least partially identical coordinates with regard to a reference axis, which is the rotational axis. “Coaxial” is to be understood to mean that two, in particular rotatably mounted, elements are arranged coaxially to each other when they are arranged rotatably around the same rotational axis.

The electric drive system has a differential gear, provided in particular in addition to the planetary gearbox, which is also referred to as a differential, axle differential or axle drive. For example, the vehicle wheels can be driven via the differential gear by the electric engine, in particular by the rotor. In particular, the differential gear can be driven via the planetary gearbox by the rotor and thus the electric engine. Thus, it is provided in particular that, in relation to a torque flow along which the respective drive torque that is or can be provided by the rotor can be transmitted to the respective vehicle wheel by the rotor, the planetary gearbox and the differential gear are arranged in the torque flow in such a way that the planetary gearbox is arranged downstream of the rotor and upstream of the differential gear and the differential gear is arranged downstream of the planetary gearbox and upstream of the respective vehicle wheel.

It is advantageous that the differential gear is arranged coaxially to the planetary gearbox. Advantageously, both the rotor, as well as the differential gear and the planetary gearbox are arranged coaxially to each other.

According to the invention, the differential gear has a first crown wheel, in particular as a first output gear, and a second crown wheel, in particular as a second output gear. The respective drive torque can be introduced into the planetary gearbox by the rotor, for example. The planetary gearbox can, for example, provide a respective input torque resulting from the respective drive torque introduced into the planetary gearbox, which input torque can be introduced into the differential gear. The differential gear can, for example, distribute the respective input torque, introduced into the differential, in particular equally to the vehicle wheels, in particular to the crown wheels, so that, for example, the respective crown wheel can provide a respective output torque, resulting from the respective input torque. Therefore, the respective vehicle wheel can be driven by means of the respective provided output torque.

According to the invention, the differential gear has pinion gears. The crown wheels and the pinion gears are designed as gear wheels. The pinion gears are arranged axially, i.e., in the axial direction of the electric drive system and thus between the crown wheels, as viewed along the rotational axis, wherein the pinion gears mesh, in particular simultaneously, with the respective crown wheels. For example, a first of the crown wheels has a first toothing on its first axial end face and, for example the second crown wheel has a second toothing on its second axial end face. For example, the first axial end face is facing towards the second axial end face in the axial direction of the electric drive system and vice versa, so that the axial end faces and thus the toothings are facing towards each other in the axial direction of the drive system. Therefore, the pinion gears engage into the toothings of the crown wheels, so that the pinion gears mesh with the crown wheels. In particular, the pinion gears are arranged in the axial direction of the drive system between the axial end faces.

The respective pinion gear is arranged, in particular rotatably, on a respective bearing bolt and, for example, the respective pinion gear is rotatably mounted on the respective associated bearing bolt. The respective bearing bolt is connected, in particular permanently, to the first planetary carrier for conjoint rotation and to the second ring gear for conjoint rotation, so that, for example, the first planetary carrier and the second ring gear are connected, in particular permanently, to each other for conjoint rotation. The respective bearing bolts of the respective pinion gear therefore define a respective pinion gear rotational axis, around which the respective pinion gear is rotatably mounted on the respective bearing bolt of the pinion gear. The respective pinion gear rotational axis is therefore arranged perpendicular to the rotational axis of the planetary gearbox. The respective pinion gear rotational axis is also arranged perpendicular to the planetary gear bolts (more precisely: to rotational axes, which are defined by the planetary gear bolts). Planetary gear bolts help with mounting the planetary gears of the planetary gearbox. Planetary gear bolts, or more precisely, rotational axes which are defined by the planetary gear bolts, are arranged parallel to the rotational axis of the planetary gearbox.

A housing wall is arranged axially adjacent to the planetary gearbox. For example, the housing wall is arranged in the axial direction of the drive system between the electric engine and the planetary gearbox and, for example, it is conceivable that the differential gear and the planetary gearbox are arranged on a first wall side of the housing wall, wherein, for example, the electric engine is arranged on a second wall side of the housing wall. Therefore, the first housing wall is facing away from the second housing wall in the axial direction of the electric engine and vice versa. In particular, the housing wall is a wall of the mentioned housing, also referred to as a wall change.

The electric drive system also comprises a brake switching element, which is also referred to as a switching element. The brake switching element is designed to connect the first ring gear to the housing wall for conjoint rotation and thus to the housing for conjoint rotation. Therefore, a housing-side switching half of the brake switching element is arranged on the housing wall, in particular in such a way that the housing-side switching half is connected, in particular permanently, to the housing wall for conjoint rotation. In other words, the first ring gear can be connected by means of the brake switching element to the housing wall for conjoint rotation. For example, the brake switching element can be switched between a first coupled state and a first decoupled state. In the first coupled state, the first ring gear is connected by means of the brake switching element to the housing wall for conjoint rotation. In the first decoupled state, the brake switching element releases the first ring gear for rotation taking place around the rotational axis and relative to the housing wall. For example, the brake switching element can be moved, in particular relative to the housing or the housing wall and/or translationally, between at least one first coupled position bringing about the first coupled state and at least one first decoupled position bringing about the first decoupled state. This is to be understood to mean, in particular, that at least one switching part of the brake switching element can be moved between the first decoupled position and the first coupled position. The switching part is or comprises, for example, friction discs. In particular, it is conceivable that the brake switching element is a multi-disc clutch, also referred to as a friction coupling or designed as a friction coupling, the disc carrier of which is arranged coaxially to the planetary gear sets, for example.

Because the second planetary gear set is arranged radially outside and axially overlapping the first planetary gear set, the planetary gear sets are stacked, in particular stacked with one another, at least partially, in particular at least predominantly and thus by more than half or even completely, with regard to the rotational axis, whereby a particularly compact construction can be achieved in particular in the axial direction of the drive system. The first crown wheel and the second crown wheel are gear wheels designed, in particular, as output gear wheels. Since the output gear wheels are crown wheels, the differential gear is designed as a crown wheel differential, whereby a particularly compact construction can be achieved. Since the housing-side switching half of the brake switching element is arranged on the housing wall, the housing-side switching half is attached to the housing wall, also referred to as an intermediate wall or designed as an intermediate wall. As a result, particularly advantageous noise behavior can be achieved, wherein the noise behavior is also referred to as NVH—behavior (NVH—noise vibration harshness). Furthermore, the brake switching element enables a particularly customized and advantageous switchability of the drive system.

In the scope of the present disclosure, ordinal numbers, also referred to as ordinals, such as for example “first” and “second” etc. are not necessarily used, in order to specify or imply a number or amount, but to be able to reference clearly to terms to which the ordinal numbers are assigned or to which the ordinal numbers refer.

In the context of the present disclosure, the feature that two components are connected to each other for conjoint rotation is to be understood as meaning that the components connected to each other for conjoint rotation are arranged coaxially to each other and, particularly when the components are driven, they rotate together or simultaneously around a component rotational axis common to the components, such as for example the mentioned rotational axis, at the same angular velocity, in particular relative to the housing. The feature that two components are connected to each other in a torque-transmitting manner means that the components are coupled to each other in such a way that torques can be transmitted between the components, in which case if the components are connected to each other for conjoint rotation, the components are also connected to each other in a torque-transmitting manner.

The feature that two components are permanently connected to each other in a torque-transmitting manner means that, rather than a switching element being provided which can be switched between a coupled state connecting the components to each other in a torque-transmitting manner and a decoupled state in which no torques can be transmitted between the components via the switching element, instead the components are constantly or always and thus permanently coupled to each other in a torque-transmitting manner, i.e., in such a way that a torque can be transmitted between the components. This means, for example, that one of the components can be driven by the respective other component or vice versa. In particular, the feature that two components are connected to each other for conjoint rotation means that rather than a switching element being provided which can be switched between a coupled state in which the components are connected to each other for conjoint rotation and a decoupled state in which the components are decoupled from each other and can be rotated relative to each other, so that torques cannot be transmitted between the components via the switching element, instead the components are constantly or always, i.e. permanently, connected or coupled to each other for conjoint rotation.

The feature that two components can be connected to each other for conjoint rotation or in a torque-transmitting manner means, in particular, that the components are assigned a switching element which can be switched between at least one coupled state and at least one decoupled state. In the coupled state, the components are connected to each other by means of the switching element, such as for example by means of the brake switching element, for conjoint rotation or in a torque-transmitting manner. In the decoupled state, the components are decoupled from each other, so that in the decoupled state the components can be rotated relative to each other, in particular around the component rotational axis, and in particular so that torques cannot be transmitted between the components via the switching element.

Thus, “for conjoint rotation” is to be understood to mean that two elements, of which at least one or both are rotatably mounted for example, are connected to each other for conjoint rotation, when they are arranged coaxially to each other and are connected to each other in such a way that they rotate at the same angular velocity.

The feature that an element is designed in one piece means that the element is designed as a single piece. The element thus does not have connecting point, such as for example a joining point. Expressed again in other words, the one-piece element is produced, for example, by primary forming and thus by casting or forging, so that the one-piece element, i.e., the element designed as a single piece, is a cast part or forged part. Expressed, in other words, the one-piece element is not composed of several parts designed separately from each other and connected to each other, but the one-piece element is formed from a single piece so that the one-piece element is formed by a monoblock or is designed as a monoblock.

In order to be able to keep the installation space requirement of the electric drive system within a particularly low limit, in particular in the axial direction of the electric drive system and thus viewed along the rotational axis, it is also provided according to the invention that with regard to the rotational axis of the planetary gearbox, i.e., viewed along the rotational axis of the planetary gearbox, the rotor, the housing wall, the planetary gearbox, the first crown wheel, and the second crown wheel are arranged in the mentioned order, i.e., in the order in which they are named, i.e., one after the other. In other words, it is preferably provided that along the rotational axis of the planetary gearbox and thus viewed in the axial direction of the drive system, the rotor, the housing wall, the planetary gearbox, the first crown wheel, and the second crown wheel are arranged successively in the following order: the rotor—the housing wall—the planetary gearbox—the first crown wheel—the second crown wheel. Expressed again in other words, the housing wall adjoins the rotor in the axial direction of the drive system, and the planetary gearbox adjoins the housing wall in the axial direction, and the first crown wheel adjoins the planetary gearbox in the axial direction, and the second crown wheel adjoins the first crown wheel in the axial direction.

Furthermore, a one-piece carrier element, i.e., a carrier element designed as a single piece, is provided according to the invention. The carrier element according to the invention has a plate section, a first cylinder section, and second cylinder section. The respective cylinder section is, for example, cylindrical on the inner circumference and/or outer circumference, i.e., in the form of a straight circular cylinder, in particular a hollow cylinder. The plate section, the first cylinder section, and the second cylinder section are arranged coaxially to each other. Planetary gear bolts for the first planetary gears of the planetary gearbox are arranged on the plate section. In particular, the respective planetary gear bolt is fixed on the plate section for conjoint rotation. For example, a respective one of the first planetary gears is, in particular rotatably, mounted on the respective planetary gear bolt. The first planetary gears are, for example, components of the first planetary gear set, wherein, for example, the respective first planetary gear meshes, in particular simultaneously, with the first sun gear and with the first ring gear. For example, the second ring gear is arranged on a radial, i.e., pointing inwards in the radial direction of the drive system, inner side of the first cylinder section, in particular in such a way that the second ring gear is connected, in particular permanently, to the radial inner side of the first cylinder section for conjoint rotation. The radial inner side of the third cylinder section is also referred to as a first radial inner side. Furthermore, it is preferably provided that pinion bolts for the pinion gears are arranged on a radial inner side of the second cylinder section, also referred to as a second radial inner side. In this case, a respective one of the pinion gears is held, in particular mounted, in particular rotatably on the respective pinion bolt, for example. For example, the respective pinion bolt is fixed on the second radial inner side of the second cylinder section, for conjoint rotation. The one-piece carrier element is thus, for example, a component of the first planetary carrier. A particularly compact and weight-optimized construction can be achieved by using the proportionate carrier element.

A further embodiment is characterized by a further brake switching element, which is also referred to as a second switching element. It is conceivable that the first brake switching element is designed as a friction brake. For example, the further brake switching element is designed as a positive-locking switching element, i.e., for example as a claw coupling. The further brake switching element is designed to connect the second planetary carrier to the housing for conjoint rotation. In other words, the second planetary carrier can be connected to the housing by means of the further switching element, for conjoint rotation. For example, the further brake switching element can be switched between a second coupled state into a second decoupled state. In the second coupled state, the second planetary carrier is connected by means of the second switching element (further brake switching element) to the housing for conjoint rotation. In the second decoupled state, the further brake switching element releases the second planetary carrier for rotation taking place around the rotational axis and relative to the housing. For example, the further brake switching element, i.e., at least one further switching part of the further brake switching element, can be moved, in particular relative to the housing and/or translationally, between at least one second coupled position, which brings about the second coupled state, and at least one second decoupled position, which brings about the second decoupled state. Therefore, advantageous switchability of the drive system can be achieved in a space-efficient manner.

Lastly, it has proved to be particularly advantageous for implementing a particularly weight-optimized and space-efficient construction of the drive system if the electric engine is designed as an axial flow machine.

For example, the one-piece carrier element is formed from a light metal, in particular from aluminum. More preferably, the carrier element is designed as an aluminum cast part

The respective planetary gear bolt is, for example, designed as one piece or as a single piece. The respective planetary gear bolt can be formed, for example, from a metallic material, in particular from steel, so that, for example, the respective planetary gear bolt is designed as a steel bolt. Furthermore, it is conceivable that the respective pinion bolt is designed as one piece, i.e., as a single piece. In particular, it is conceivable that the respective pinion bolt is formed from a metallic material, in particular from a steel, so that the respective pinion bolt can be a steel bolt.

A second aspect of the invention relates to a motor vehicle, preferably designed as an automobile, in particular as a passenger car and also referred to as a vehicle, which has an electric drive system according to the first aspect of the invention and which can be driven electrically by means of the electric drive system, in particular purely electrically. Advantages and advantageous embodiments of the first aspect of the invention are to be regarded as advantages and advantageous embodiments of the second aspect of the invention and vice versa.

Further advantages, features and details of the invention result from the following description of preferred exemplary embodiments and using the drawing. The features and combinations of features mentioned above in the description as well as the features and combinations of features mentioned below in the description of the figures and/or shown alone in the figures can be used not only in the combination indicated in each case, but also in other combinations or on their own, without leaving the scope of the invention.

### BRIEF DESCRIPTION OF THE DRAWING FIGURES

The drawing shows in:

FIG. 1 a schematic representation of a first embodiment of an electric drive system for a motor vehicle; and

FIG. 2 a schematic representation of a second embodiment of the electric drive system.

In the figures, identical or functionally identical elements are provided with the same reference numerals.

### DETAILED DESCRIPTION

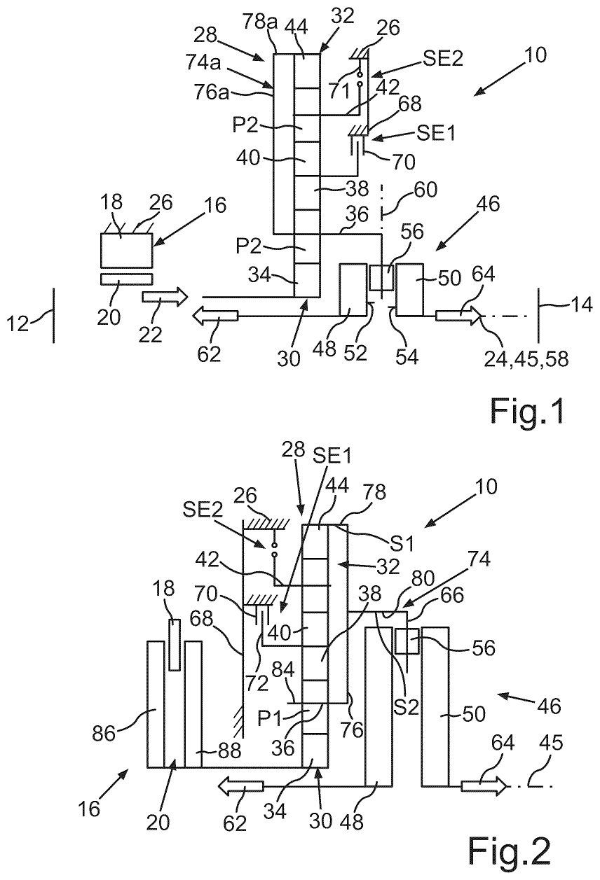

FIG. 1 shows, in a schematic representation, a first embodiment of an electric drive system 10 for a motor vehicle. This means that a motor vehicle, also simply referred to as a vehicle, in its completely produced state has the drive system 10 and can be driven electrically by means of the drive system 10, in particular purely electrically. The motor vehicle has at least or exactly two vehicle axles arranged in succession in the vehicle longitudinal direction of the motor vehicle and thus one behind the other. The respective vehicle axle has at least or exactly two vehicle wheels, wherein the respective vehicle wheels of the respective vehicle axle are arranged on opposite sides to each other in the vehicle transverse direction of the motor vehicle. The vehicle wheels of at least or exactly one of the vehicle axles can be driven electrically by means of the drive system 10. The vehicle wheels driven by means of the drive system 10 are represented particularly schematically in FIG. 1 and referenced with 12 and 14.

The electric drive system 10 has an electric engine 16 which has a stator 18 and a rotor 20. The electric engine 16 can provide respective drive torques via its rotor 20 for driving the vehicle wheels 12 and 14. The respective drive torque is illustrated in FIG. 1 by an arrow 22. The rotor 20 can be driven by means of the stator 18 and thus can be rotated around an engine rotational axis 24, relative to the stator 18 and also relative to a housing 26 of the drive system 10.

The drive system 10 has a planetary gearbox 28, which has a first planetary gear set 30 and a second planetary gear set 32. The first planetary gear set 30 has a first sun gear 34, a first planetary carrier 36, and a first ring gear 38. The second planetary gear set 32 has a second sun gear 40, a second planetary carrier 42, and a second ring gear 44. The first planetary gear set 30 has first planetary gears, of which a first planetary gear labelled P1 can be seen in FIG. 1. As can be seen using the example of the planetary gear P1, the planetary gears P1 are rotatably held on the planetary carrier 36, in particular mounted thereon. The respective planetary gear P1 meshes, in particular simultaneously, with the sun gear 34 and with the ring gear 38. The planetary gear set 32 has second planetary gears, of which a second planetary gear labelled with P2 is shown in FIG. 1. It can be seen, using the example of the second planetary gear P2, that the second planetary gears P2 are rotatably held on the planetary carrier 42, in particular mounted thereon. The respective planetary gear P2 meshes, in particular simultaneously, with the sun gear 40 and with the ring gear 44.

The second planetary gear set 32 is arranged radially outside and axially overlapping the first planetary gear set 30 with regard to a rotational axis 45 of the planetary gearbox 28, also referred to as a planetary gear set rotational axis, so that the planetary gear sets 30 and 32 are stacked, in particular stacked on each other, in an axial direction of the planetary gearbox 28 and of the drive system 10, coinciding with the rotational axis 45. In the first embodiment, the planetary gear sets 30 and 32 are stacked on each other in such a way that the planetary gear set 32 is arranged on the planetary gear set 30 or is stacked on the planetary gear set 30. In other words, the planetary gear set 30 is arranged at least partially, in particular at least predominantly and thus more than half or even completely, in the second planetary gear set 32, when viewed in the axial direction of the drive system 10 and thus along the rotational axis 45. The sun gears 34 and 40, the planetary carriers 36 and 42, and the ring gears 38 and 44 are gear elements of the planetary gearbox 28. Particularly if the respective gear element is not connected to the housing 26 for conjoint rotation, the respective gear element can be rotated around the rotational axis 45, relative to the housing 26. It can be seen that the planetary gear sets 30 and 32 are arranged coaxially to each other, and the electric engine 16 is arranged coaxially to the planetary gear sets 30 and 32, so that the engine rotational axis 24 coincides with the rotational axis 45.

The drive system 10 also has a differential gear 46 which is designed as a crown wheel differential. The differential gear 46 has a first crown wheel 48, as a first output gear wheel, and a second crown wheel 50, as a second output gear wheel. The output gear wheels are gear wheels. The crown wheel 48 has a first axial end face 52 and the crown wheel 50 has a second axial end face 54. The axial end faces 52 and 54 are facing towards each other in the axial direction of the drive system 10 and thus as viewed along the rotational axis 45. The crown wheel 48 has a first toothing in or on the end face 52, and the crown wheel 50 has a second toothing in or on the end face 54. Thus, the toothings are facing towards each other in the axial direction of the drive system 10.

The differential gear 46 also has pinion gears, of which a pinion gear labelled with 56 can be seen in FIG. 1. The respective pinion gear 56 is a further gear wheel of the differential gear 46. The respective pinion gear 56 is arranged in the axial direction of the planetary gearbox 28 and thus of the drive system 10 between the crown wheels 48 and 50, in particular between the end faces 52 and 54. In this case, the pinion gears 56 mesh, in particular simultaneously, with the crown wheels 48 and 50. The pinion gears 56 can be rotated around a differential rotational axis 58 relative to the housing 26. Furthermore, the respective pinion gear 56 can be rotated around a respective pinion gear rotational axis 60, also referred to as a compensation rotational axis, relative to the housing 26, wherein the respective pinion gear rotational axis 60 extends perpendicular to the differential rotational axis 58. It can be seen that the differential gear 46 is arranged coaxially to the planetary gear sets 30 and 32, i.e., coaxially to the planetary gearbox 28 and also coaxially to the electric engine 16, so that the differential rotational axis 58 having an engine rotational axis 24 coincides with the rotational axis 45.

The respective drive torque that is or can be provided by the arrow 22 can be introduced into the planetary gearbox 28. The planetary gearbox 28 can provide, in particular via the planetary carrier 36, a respective input torque resulting from the respective drive torque, which in particular can be introduced into the differential gear 46 via the pinion gears 56. The differential gear 46 can distribute or transmit the respective input torque, in particular equally, to the vehicle wheels 12 and 14, in particular in such a way that the respective crown wheel 48, 50 can provide a respective output torque resulting from the respective input torque. The output torque that can be provided by the crown wheel 48 is illustrated in FIG. 1 by an arrow 62, and the output torque that can be provided by the crown wheel 50 is illustrated by an arrow 64. It can be seen that the vehicle wheel 12 can be driven by means of the output torque illustrated by the arrow 62 and thus by means of the crown wheel 48, and the vehicle wheel 14 can be driven by means of the output torque illustrated by the arrow 64 and thus by means of the crown wheel 50. The crown wheels 48 and 50 are arranged coaxially to each other and can be rotated around the differential rotational axis 58 relative to the housing 26 and in particular relative to each other. In particular, the differential gear 46 has the functionality, already sufficiently known from the general prior art, that the differential gear 46 enables different rotational speeds in the vehicle wheels 12 and 14, in particular when the motor vehicle is cornering, in particular in such a way that the outside vehicle wheel rotates or can rotate with a greater rotational speed than the inside vehicle wheel, in particular when the vehicle wheels 12 and 14 are connected to the rotor 20 in a torque-transmitting manner and thus can be or are driven by the rotor 20.

The respective pinion gear 56 is arranged on a respective bearing bolt 66, in particular rotatably. The respective bearing bolt 66 is, in particular permanently, connected to the planetary carrier 36 for conjoint rotation and, in particular permanently, connected to the second ring gear 44 for conjoint rotation. Thus, it is provided in particular that the second ring gear 44 and the first planetary carrier 36 are, in particular permanently, connected to each other for conjoint rotation. It can be seen that the ring gear 44 and the planetary carrier 36 form an output drive of the planetary gearbox 28, which can provide the respective input torque, which results from the respective output torque, via its output drive.

In the first embodiment shown in FIG. 1, a housing wall 68, which is a wall of the housing 26, is arranged axially adjacent to the planetary gearbox 28. The housing wall 68 extends radially, i.e., in relation to the rotational axis 45 in the radial direction of the planetary gearbox 28 and thus of the drive system 10, the radial direction of which extends perpendicular to the mentioned axial direction of the planetary gearbox 28 and thus of the drive system 10. In the first embodiment, the housing wall 68 is arranged on an axial side of the planetary gearbox facing away from the rotor 20. Both a first brake switching element SE1 and a second brake switching element SE2 each have a switching half connected directly to the housing wall 68 for conjoint rotation, specifically a first switching half 70 of the first brake switching element SE1 and a third switching half 71 of the second brake switching element SE2. The first brake switching element SE1 is designed to connect the second sun gear 40 and the first ring gear 38 to the housing 26 for conjoint rotation. The second brake switching element is designed to connect the second planetary carrier 42 to the housing 26 for conjoint rotation. The first brake switching element SE1 and the second brake switching element SE2 are advantageously arranged axially overlapping each other. Advantageously, the second brake switching element SE2 is arranged axially outside the first brake switching element SE1.

In the first embodiment, shown in FIG. 1, the electric engine 16 is designed as a radial flow machine.

FIG. 2 shows a second embodiment of the drive system 10. As can be seen from FIG. 2, the housing wall 68, which is a wall of the housing 26, is also arranged axially adjacent to the planetary gearbox 28 in the second embodiment.

The drive system 10 also has the first brake switching element SE1 in the second embodiment, by means of which the first ring gear 38 can be connected to the housing 26 and thus to the housing wall 68 for conjoint rotation. Therefore, the housing-side first switching half 70 of the first brake switching element SE1 is arranged on the housing wall 68, in particular in such a way that the first switching half 70 is connected, in particular permanently, to the housing wall 68 for conjoint rotation. For example, a wheel-side, second switching half 72 of the first brake switching element SE1 is arranged on the first ring gear 38, in particular permanently connected to the first ring gear 38 for conjoint rotation.

It can be seen that in the second embodiment, with regard to an axial direction of the rotational axis 45 of the planetary gearbox 28 and thus in the axial direction of the planetary gearbox 28 and of the drive system 10, the rotor 20, the housing wall 68, the planetary gearbox 28, the first crown wheel 48 and the second crown wheel 50 are arranged successively in the following order: the rotor 20—the housing wall 68—planetary gearbox 28—the first crown wheel 48—the second crown wheel 50.

The drive system 10 also comprises the second brake switching element SE2 in the second embodiment, by means of which the second planetary carrier 42 can be connected to the housing 26 for conjoint rotation.

The electric drive system 10, in its second embodiment, comprises a carrier element 74 designed as a single piece, i.e., as one piece, which is a component of the planetary carrier 36 or forms the planetary carrier 36, for example. The carrier element 74 has a plate section 76, a first cylinder section 78, and a second cylinder section 80. The respective pinion gear 56 is, in particular rotatably, held, in particular mounted, on the respective bearing bolt 66, also referred to as a pinion bolt. The respective, first planetary gear P1 is in particular rotatably held, in particular mounted, on a respective planetary gear bolt 84. It can be seen from FIG. 2 that the planetary gear bolts 84 for the first planetary gears P1 are arranged, in particular fixed, on the plate section 76, in particular for conjoint rotation. For example, the planetary gear bolts 84 are designed separately from the carrier element 74 and thus from the plate section 76 and are held, in particular fixed, on the plate section 76, in particular for conjoint rotation. On a first radial inner side S1 of the second cylinder section 78, the second ring gear 44 is arranged, in particular fixed, in particular for conjoint rotation. It is conceivable that the ring gear 44 is designed separately from the carrier element 74 and thus separately from the first cylinder section 78, and is arranged, in particular fixed, on the first radial inner side S1 and thus on the first cylinder section 78, in particular for conjoint rotation. Furthermore, it is conceivable that the ring gear 44 is designed as a single piece with the carrier element 74, so that the one-piece carrier element 74 forms the second ring gear 44. The pinion gears (bearing bolts 66) are arranged, in particular held or fixed, on a second radial inner side S2, in particular for conjoint rotation. For example, the respective pinion bolt is designed separately from the carrier element 74 and thus separately from the second cylinder section 80, and is held, in particular fixed, on the first cylinder section 78 and thus on the carrier element 74, in particular for conjoint rotation.

In the first embodiment of FIG. 1, a one-piece carrier element 74a is similarly present, having a plate section 76a and a first cylinder section 78a. Planetary gear bolts of the first planetary gear carrier 36 are advantageously connected as one piece to the one-piece carrier element 74a of the first embodiment.

Furthermore, it can be seen from FIGS. 1 and 2 that the ring gear 38 is, in particular permanently, connected to the sun gear 40 for conjoint rotation.

In the second embodiment, the electric engine 16 is designed as an axial flow machine, the rotor 20 of which has two rotor elements 86 and 88, spaced apart from each other in the axial direction and designed, for example, as rotor discs. In this case, at least one partial region of the stator 18 is arranged in the axial direction between the rotor elements 86 and 88 in such a way that the rotor element 88 is overlapped by the partial region of the stator 18 in a first overlapping direction, that extends parallel to the axial direction and points from the rotor element 88 and the rotor element 86. Consequently, the rotor element 86 is overlapped by the partial region of the stator 18 in a second overlapping direction, which extends parallel to the axial direction of the drive system 10, is counter to the first overlapping direction and points from the rotor element 86 and the rotor element 88.

### LIST OF REFERENCE NUMERALS

10 electric drive system
12 vehicle wheel
14 vehicle wheel
16 electric engine
18 stator
20 rotor
22 arrow
24 engine rotational axis
26 housing
28 planetary gearbox
30 first planetary gear set
32 second planetary gear set
34 first sun gear
36 first planetary carrier
38 first ring gear
40 second sun gear
42 second planetary carrier
44 second ring gear
45 rotational axis
46 differential gear
48 first crown wheel
50 second crown wheel
52 first axial end face
54 second axial end face
56 pinion gear
58 differential rotational axis
60 pinion gear rotational axis
62 arrow
64 arrow
66 pinion bolt
68 housing wall
70 first switching half
71 third switching half
72 second switching half
74 carrier element
76 plate section
78 first cylinder section
80 second cylinder section
84 planetary gear bolts
86 rotor element
88 rotor element
S1 first radial inner side
S2 second radial inner side
SE1 first brake switching element
SE2 second brake switching element

1-5. (canceled)

6. An electric drive system for a motor vehicle, the electric drive system comprising:
a housing having a housing wall;
an electric engine comprising a stator and a rotor;
a planetary gearbox comprising
a first planetary gear set comprising a first sun gear, a first planetary carrier, and a first ring gear; and
a second planetary gear set comprising a second sun gear, a second planetary carrier, and a second ring gear, wherein the second planetary gear set is arranged radially outside and axially overlapping the first planetary gear set with regard to a rotational axis of the planetary gearbox;
a first brake switching element configured to connect the first ring gear to the housing wall to conjointly rotate, wherein a housing-side switching half of the first brake switching element is arranged on the housing wall; and
a differential gear comprising a first crown wheel, a second crown wheel, and pinion gears, wherein the pinion gears arranged axially between the first and second crown wheels and mesh with the first and second crown wheels, wherein the pinion gears are in each case are arranged on a respective bearing bolt connected to the first planetary carrier to conjointly rotate and to the second ring gear to conjointly rotate, wherein the housing wall is a radially extending housing wall arranged axially adjacent to the planetary gearbox; and
a one-piece carrier element comprising a plate section, a first cylinder section, and a second cylinder section, wherein planetary gear bolts for first planetary gears of the planetary gearbox are arranged on the plate section, wherein the second ring gear is arranged on a radial inner side of the first cylinder section, and wherein the bearing bolts are arranged as pinion bolts for the pinion gears on a radial inner side of the second cylinder section,
wherein the rotor, the housing wall, the planetary gearbox, the first crown wheel, and the second crown wheel are arranged successively in the following order with regard to the rotational axis of the planetary gearbox-the rotor, the housing wall, the planetary gearbox, the first crown wheel, and the second crown wheel.

7. The electric drive system of claim 6, further comprising:
a second brake switching element configured to connect the second planetary carrier to the housing of the electric drive system for conjoint rotation.

8. The electric drive system of claim 6, wherein the first ring gear is permanently connected to the second sun gear to conjointly rotate.

9. An electric drive system of claim 6, wherein the electric engine is an axial flow machine.

10. A motor vehicle comprising:
first and second vehicle wheels; and
an electric drive system coupled to the first and second vehicle wheels, wherein the electric drive system comprises
a housing having a housing wall;
an electric engine comprising a stator and a rotor;
a planetary gearbox comprising
a first planetary gear set comprising a first sun gear, a first planetary carrier, and a first ring gear; and
a second planetary gear set comprising a second sun gear, a second planetary carrier, and a second ring gear, wherein the second planetary gear set is arranged radially outside and axially overlapping the first planetary gear set with regard to a rotational axis of the planetary gearbox;
a first brake switching element configured to connect the first ring gear to the housing wall to conjointly rotate, wherein a housing-side switching half of the first brake switching element is arranged on the housing wall; and
a differential gear comprising a first crown wheel, a second crown wheel, and pinion gears, wherein the pinion gears arranged axially between the first and second crown wheels and mesh with the first and second crown wheels, wherein the pinion gears are in each case are arranged on a respective bearing bolt connected to the first planetary carrier to conjointly rotate and to the second ring gear to conjointly rotate, wherein the housing wall is a radially extending housing wall arranged axially adjacent to the planetary gearbox; and
a one-piece carrier element comprising a plate section, a first cylinder section, and a second cylinder section, wherein planetary gear bolts for first planetary gears of the planetary gearbox are arranged on the plate section, wherein the second ring gear is arranged on a radial inner side of the first cylinder section, and wherein the bearing bolts are arranged as pinion bolts for the pinion gears on a radial inner side of the second cylinder section,
wherein the rotor, the housing wall, the planetary gearbox, the first crown wheel, and the second crown wheel are arranged successively in the following order with regard to the rotational axis of the planetary gearbox-the rotor, the housing wall, the planetary gearbox, the first crown wheel, and the second crown wheel.
